(19) United States
(12) Patent Application Publication
(10) Pub. No.: US 2003/0088487 A1
(43) Pub. Date: May 8, 2003

(54) Travel expense reimbursement system and method

(76) Inventors: Wen-Che Cheng, Taipei Hsien (CN); Pei-Yi Lin, Taipei Hsien (CN); Tsuey-Jing Fan, Taipei Hsien (CN)

Correspondence Address: Michael D. Bednarek, SHAWPITTMAN, 1650 Tysons Boulevard, McLean, VA, 22102-4859, US

(21) Appl. No.: 10/086,864

(22) Filed: Mar. 4, 2002

(30) Foreign Application Priority Data
Nov. 8, 2001 (CN) 090113373

(51) Int. Cl. G06F 17/60

(52) U.S. Cl. 705/30; 705/38

(57) ABSTRACT

A travel expense reimbursement system and a method for the same are introduced. The reimbursement system can receive employee's credit card charging data from a credit card company and then can store the charging data into a database. Each of the charging data is respective to a credit card identification code. When the employee uses an employee's identification code to login the reimbursement system, the reimbursement system can base on the employee's identification code to retrieve the charging data with respect to the credit card identification code of the employee's identification code. The employee is allowed to edit the respective charging data and to restore the charging data into the database. The reimbursement system and method can also have the supervisor of the employee to confirm the charging data and then an accounting system to reimburse the travel expense to the employee.

### REFERENCE TO RELATED APPLICATION

The present application claims priority to Taiwan application No. 090113373, entitled “Travel Expense Reimbursement System And Method,” filed on Jun. 1, 2001.

### BACKGROUND OF THE INVENTION

(1) Field of the Invention

The invention relates to a travel expense reimbursement system and a method for the same, and more particularly to the system and the method which can integrate expenditures of credit cards with existing travel expense reimbursement procedures of a business entity.

(2) Description of the Prior Art

In the trend of internationalization, travel expenses share a substantial portion of yearly fixed expenditures for most of middle to large-size enterprises. Normally, the travel expenses is ranked the third in controllable expenditures of a company, which is only less than the expenditures for salaries and taxes. To have a better control upon the travel expenses, most enterprises usually have their own internal guidelines or policies for employee's travel expenses so that the travel expenses can be appropriately regulated. Among those guidelines, one of the solutions is that the travel expenses can only be reimbursed for those paid only by corporate cards or credit cards issued by specific credit card companies.

Regarding the procedures for reimbursing travel expenses, current practice usually need evidences such as receipts, ticket stubs and the like. However, these evidences can be easily lost and usually need a substantial amount of time and labors to check up one by one, which is time-consuming and troublesome for the employee, the employee's supervisors, and accounting personnel. Even for those enterprises that permit expenses paid only by corporate cards or credit cards issued by specific card companies, trivial and notorious checking over the receipts is still inevitable. Meanwhile, such a checking job requires a substantial amount of time and work, and is not a profit-earning job. Also, checking, transporting and stocking of a huge amount of receipts and stubs obviously can not match with the current trend of office automation, electronic offices and paper-less offices.

### SUMMARY OF THE INVENTION

Accordingly, it is a primary object of the present invention to provide a travel expense reimbursement system and method which can integrate the credit card and the travel expense reimbursement procedures of a business entity.

It is another object of the present invention to provide a travel expense reimbursement system and method which can provide the business entity a simplified process upon reimbursing and checking the travel expenses.

In accordance with the present invention, the travel expense reimbursement method is applied to a travel expense reimbursement system of the computer facility in a business entity. Each employee of the business entity is assigned an individual employee's identification code to login the reimbursement system. During the travel, the employee can charge the expense to a credit card issued by a specific credit card company. The credit card includes an individual credit card identification code with respect to the employee's identification code.

The reimbursement system can receive charging data from the credit card company and thereafter proceed to store the charging data into a credit card charging record database. In the present invention, each of the charging data is respective to a specific credit card identification code.

When the employee uses his/her employee's identification code to login the reimbursement system, the reimbursement system can base on the employee's identification code to retrieve, from the credit card charging record database, all the charging data of the travel with respect to the credit card identification code of the employee's identification code for forming a charging record document respective to the travel. In the present invention, each of the charging record documents is respective to a specific travel.

Then, the employee can edit the retrieved charging record document and thereafter restore the edited charging record document into the credit card charging record database. The supervisor of the employee can confirm the edited charging record document and, upon approval, can restore the edited charging record document into the credit card charging record database again. After the supervisor's confirmation, an accounting system can base on the confirmed charging record document to reimburse the travel expense to the employee.

Accordingly, the novel travel expense procedures can omit the labor and cost in managing a huge amount of receipts in the prior art. The employee, the supervisor and the accounting personnel can also save their time and effort to review these receipts. Consequently, the employee will be more and more pleased to use the credit card issued by the specific credit card company and is thus a win-win strategy to the credit card company, the business entity and the employee.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The present invention will now be specified with reference to its preferred embodiment illustrated in the drawings, in which:

FIG. 1 shows a system framework in accordance with the present invention;

FIG. 2 is a flowchart of a preferred embodiment of the travel expense reimbursement method in accordance with the present invention;

FIG. 3 shows a display page of step 76 of FIG. 2 for a preferred travel expense reimbursement system in accordance with the present invention;

FIG. 4 shows a display page of step 78 of FIG. 2 for the preferred travel expense reimbursement system in accordance with the present invention; and

FIG. 5 shows a display page of step 79 of FIG. 2 for the preferred travel expense reimbursement system in accordance with the present invention.

### DESCRIPTION OF THE PREFERRED EMBODIMENT

The invention disclosed herein is directed to a travel expense reimbursement system and a method for the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

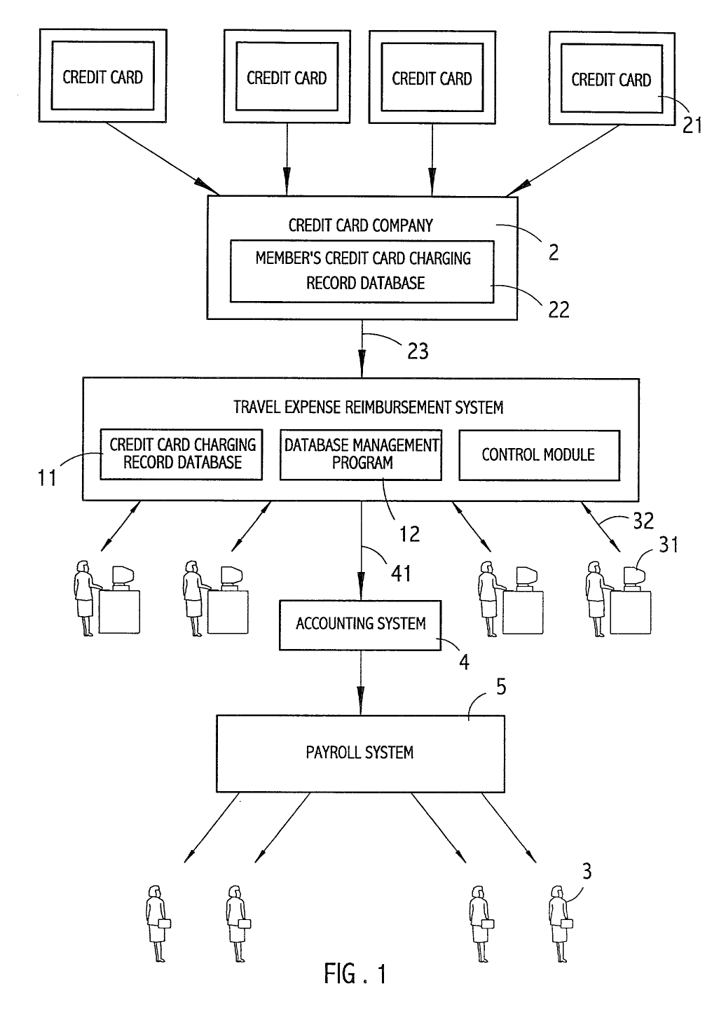

Referring now to FIG. 1, a framework of the preferred travel expense reimbursement system in accordance with the present invention is presented. The travel expense reimbursement system 1 is constructed inside a network server of the business entity. The travel reimbursement system 1 mainly includes a credit card charging record database 11 for storing employee's travel expenses charged to the credit card and a database management program 12 for managing the credit card charging record database 11. By providing the database management program 12, retrieving, editing, storing and other managing operations upon the database 11 can be proceeded. Also, the travel expense reimbursement system 1 can include a plurality of control modules 13 for performing identification on the user, data computation, interface integration and other control functions. Relationships between the travel expense reimbursement system 1 and the other entities are described as follows.

1. Credit card company 2: which maintains a cooperation relationship with the business entity for issuing credit cards 21 to employees of the business entity so that the employee can charge the travel expenses to the credit card 21. The credit card 21 can be substantial a corporate card, a membership card, a VIP card, an business identification card, a discount card, or any other electronic trading means. The credit card company 2 has a respective computer system for managing credit card charging data of the business entity's employees, which can include a member's credit card charging record database 22 for communicating, through an internet 23, with the server of the business entity having the travel expense reimbursement system 1. The computer system at the credit card company 2 side can forward real-time or batch after encryption the charging records of the employee using the credit card 21 during a travel from the member's credit card charging record database 22 of the credit card company 2 to the credit card charging record database 11 of the business entity.

2. Employee 3: which can use a terminal 31 (such as a personal computer), a WAP phone, a PDA or the like device to login, through an intranet 32 of the business entity, the websites of the business entity for establishing connection with the travel expense reimbursement system 1 in the network server of the business entity. After the employee 3 logins successfully the system, he/she can proceed to perform checking, editing and storing upon his/her charging records with the credit card 21. In the invention, the employee 3 who ranks as a supervisor can be authorized to approve or confirm, through the system 1, the charging records or related documents of his/her supervised employees 3.

3. Accounting system 4: which can use an intranet 41 to connect with the travel expense reimbursement system 1 for paying the claimed travel expenses of the employee 3 approved by his/her supervisor to the employee 3 through a payroll system 5 of a bank or any available paying mechanism.

By providing the aforesaid infrastructure, following descriptions will be expended to explain the procedures from the step that the employee 3 charges the travel expenses to the credit card during the travel to the step that the travel expenses are reimbursed to the employee 3.

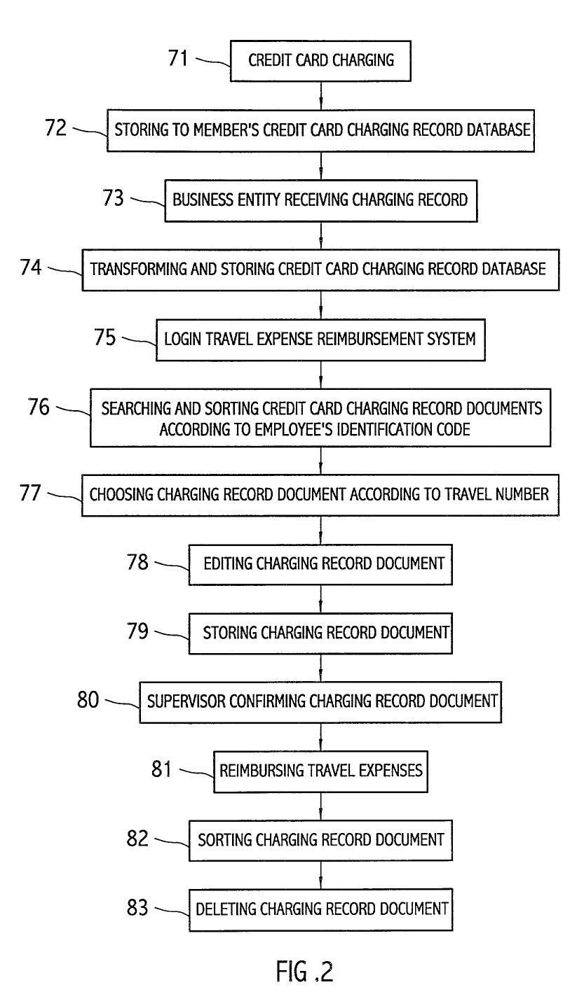

Refers now to FIG. 1 and FIG. 2 which show a preferred embodiment of the travel expense reimbursement method in accordance with the present invention. When an employee 3 of the business entity proceeds to a travel with a specific travel number, he/she is assumed to charge the expenses to the credit card 21 issued by the credit card company 2. His/her expenditures can include transportation tickets, hotel accommodations, telephone fees, gift expenses, social expenses, and other personal expending. Referring to step 71 of FIG. 2, the credit card charging can be made through any appropriate financial information network cabling to the credit card company 2 from the stores at which the credit cards are charged so as to obtain authorization and perform some general procedures such as verification upon valid date, credit limit, etc. After the transaction as well as the charging record are verified, the charging record is then stored into the member's credit card charging record database 22, which is particularly prepared by the credit card company 2 for the business entity as shown in step 72 of FIG. 2. In the present invention, each item of charging record corresponds to a credit card identification code which further corresponds to an employee's identification code of the employee 3 of the business entity. Upon such an arrangement, the credit card identification code of the charging record can be used to identify the employee's identification code upon the respective expenditure so as to identify the employee 3.

In step 73 of FIG. 2, the charging record, stored in the member's credit card charging record database 22 of the credit card company 2 including a plurality of employee's charging data with various travel numbers, times and locations, can be encrypted and then forward real-time or batch periodically (daily for example) through an appropriate internet 23 (such as a leased line) to the travel expense reimbursement system 1 of the business entity's network server. In the travel expense reimbursement system 1, the database management program 12 or other management systems of the server can decrypt the charging record and then transform the charging record into an acceptable format of the business entity for thereafter being stored in the credit card charging record database 11, as shown in step 74 of FIG. 2, in which each item of the charging record corresponds to a specific credit card identification code.

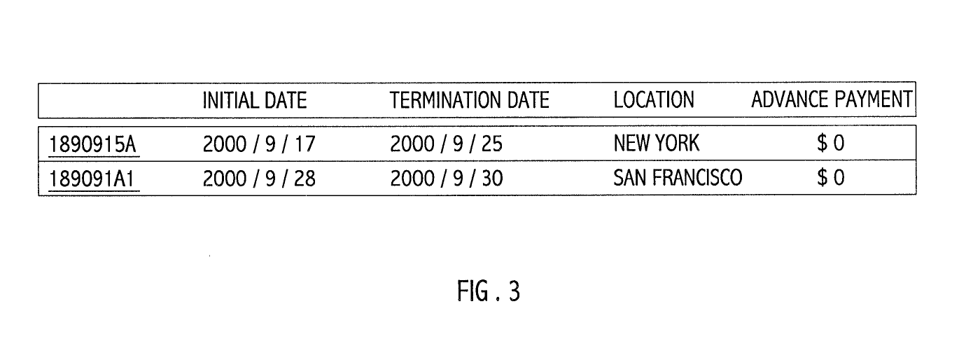

When the employee 3 completes his/her travel and proceeds to reimburse his/her travel expenses, he/she can use a personal computer 31 in the office through an intranet 32 to access the travel expense reimbursement system 1. If the employee 3 cannot return back to the office, he/she can also utilize appropriate remote terminals, WAP phones, PDA's or the like networking devices through internets to remote login the travel expense reimbursement system 1 of the business entity, so that the reimbursement process can be made without any delay. While the employee 3 keys in his/her employee's identification code and the respective password into the personal computer 31 through a browser, a keyboard, or other input devices, the travel expense reimbursement system 1 can accept his/her login only after verifying his/her employee's identification code and the password (step 75 of FIG. 2). Then, the travel expense reimbursement system 1 can base on the employee's identification code to search the credit card charging record database 11 and then to retrieve all the charging records associated with the respective credit card identification code. In step 76 of FIG. 2, the system 1 can then sort, according to the travel numbers, the charging record to form a credit card charging record document. Referring now to FIG. 3, an embodiment of the charging record document is illustrated. As shown, each travel number can also associate with an initial date, a termination date, locations, advance payment, etc.

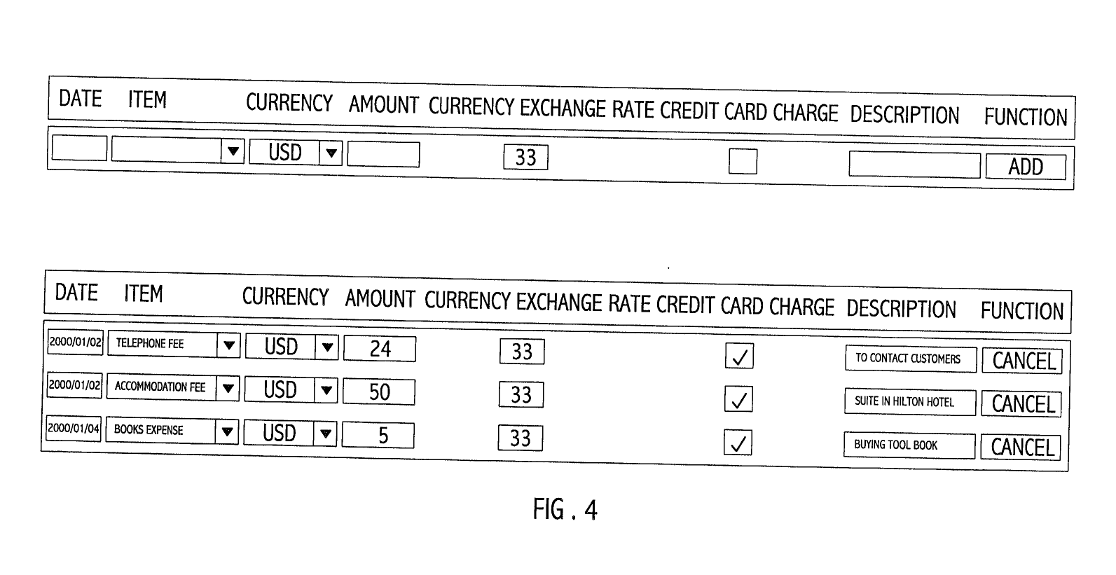

When the employee 3 clicks the travel number of FIG. 3 in performing step 77 of FIG. 2, a page as shown in FIG. 4 can be obtained to display in detail the charging records in each travel, and editing upon the charging record as step 78 of FIG. 2 can be proceeded. As shown in FIG. 4, each item of the charging record can include a date, an item, a currency, an amount, a currency exchange rate, a credit card charge (default), a description, and a cancellation function for the charging; in which the date and the amount can be captured from the credit card charging record database 11; the item, the currency and the description are filled up by the employee 3, and the currency exchange rate can be automatically obtained from a default rate in the travel expense reimbursement system 1. In the present invention, the employee 3 can also prepare a certification document to change the currency exchange rate and use a different currency exchange rate. In the case that an item of the expenses belongs to his\her personal expense, such as the charging for a tool book in FIG. 4, the employee 3 can click the “CANCEL” function to remove the respective amount from the expenses for reimbursement. On the other hand, some cash expenses or charges to credit cards other than the one issued by the credit card company 2 is possible because there are still some shops that do not accept credit card charging or that accept only some specific credit cards. In such a case, the employee 3 can include the amount into the items for reimbursement by clicking the “ADD” function at the right side of FIG. 4 after keying in the expense into the top list thereof.

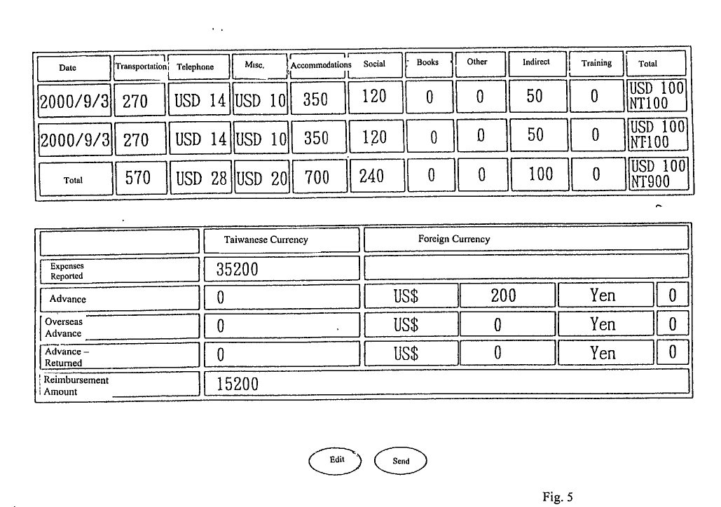

As soon as the employee 3 completes the editing of the charging record in the specific travel, the travel expense reimbursement system 1 can sum up respectively to obtain a total transportation fee, a total miscellaneous fee, a total accommodation fee, etc. in accordance with the ordering of dates, and list those subtotals to an upper portion of the travel expense reimbursement table shown in FIG. 5. By subtracting the advance payment corresponding to the travel number stored in the travel expense reimbursement system 1, the reimbursement amount to the employee 3 can be computed. In the case that the employee 3 may need to return portion of the advance payment, the payback amount can also be shown at a lower portion of the table in FIG. 5. When the employee 3 confirms all the details shown in FIG. 5, he/she can click the “SEND” option to restore the edited charging record document into the credit card charging record database 11 as step 79 of FIG. 2.

Moreover, the control module 13 of the travel expense reimbursement system 1 can utilize an intranet 32 to inform a specific supervisor of the employee 3. The supervisor is then authorized to login the system 1 and browse/review the edited charging record document of the employee 3. After the supervisor approves or confirms the edited charging record document, the document is restored into the credit card charging record database 11 as shown in step 80 of FIG. 2. In the aforesaid confirmation procedures, some particular expenses of the employee 3 may be required to provide related evidencing receipt for the supervisor's approval. For instance, the employee 3 needs to provide a list of customers involved in the social expense. When the control module 13 of the travel expense reimbursement system 1 receives the confirmed charging record document from the supervisor, an intranet 41 can be utilized to forward the confirmed charging record document to the accounting system 4 of the business entity. The confirmed reimbursement amount toward the travel expenses of the employee 3 can then be transferred into the employee's bank account by the payroll system 5 of the business entity, as step 81 shown in FIG. 2. Definitely, manual payment or other payment styles for the reimbursement are also acceptable. Before the credit card charging record database 11 deletes the charging record document that has already been processed by the accounting system 4 as step 82 of FIG. 2, the system 1 can further utilize appropriate software to sort and analyze (as step 82 of FIG. 2) the document for helping the business entity to further understand the trend of employee's travel expenses. Also, some practical statistic data can be provided to the related service providers for obtaining better discounts.

By providing the system and method for reimbursing the travel expenses in accordance with the present invention, following advantages over the existing credit card-charging or other travel expense reimbursement models can be gained.

1. Simplifying the procedures of reimbursing the travel expenses: Each item of the employee's travel expenses is charged to the specific credit card so that the reference of the expenses can be directly obtained from the credit card company 2, through a proper networking. Thereby, the employee 3 needs not to provide trivial evidences for all his/her expenses. Also, the automatic sorting and analysis function of the travel expense reimbursement system 1 not only can simplify the reimbursing procedures for the employee 3, but also reduce the checking time upon the expenses for the supervisor and the accounting department. Therefore, the human resources of the business entity can be greatly saved. Also, it is easy to see that the system and method provided by the present invention indeed match with the trends of a paper-less office and an electronic office.

2. Enhancing the usage of a single corporate credit card: Because the credit card 21 is issued by a credit card company 2 associated with the business entity, the travel expense reimbursement procedures can be easily simplified. Also, the employee will be pleased to use the credit card 21. For the credit card company 2, the high charging rate implies better profits. On the other hand, for the business entity, the design of charging the travel expenses to a single credit card 21 can be fulfilled and a better contract with the credit card company 2 can be also obtained. Therefore, by providing the present invention, a win-win strategy can be gained at either side among the business entity, the employee 3 and the credit card company 2.

While the present invention has been particularly shown and described with reference to a preferred embodiment, it will be understood by those skilled in the art that various changes in form and detail may be without departing from the spirit and scope of the present invention.

What is claimed is:

1. A travel expense reimbursement method, applied to a travel expense reimbursement system of the computer facility in a business entity, each employee of the business entity having an individual employee's identification code for the respective employee to login the reimbursement system, the employee charging the expenses to a credit card issued by a specific credit card company during his/her traveling, the credit card including an individual credit card identification code with respect to the employee's identification code, said method comprising the steps of:
receiving by the reimbursement system the charging data from the credit card company and thereafter storing the charging data into a credit card charging record database, in which each of the charging data is respective to a credit card identification code;
login-ing the reimbursement system by the employee using the employee's identification code, the reimbursement system based on the employee's identification code to retrieve, from the credit card charging record database, all charging data of a travel with respect to the credit card identification code and the employee's identification code for forming a charging record document respective to the travel; and
editing by the employee the charging record document and thereafter restoring the edited charging record document into the credit card charging record database.

2. The travel expense reimbursement method according to claim 1 further includes the step of: after said employee restoring said edited charging record document into said credit card charging record database, notifying by said reimbursement system the supervisor of said employee to login said travel expense reimbursement system to access said edited charging record document, and restore said edited charging record document into said credit card charging record database after the supervisor confirming said edited charging record document.

3. The travel expense reimbursement method according to claim 2 further includes the step of: after said supervisor confirming said edited charging record document and restoring the confirmed edited charging record document into said credit card charging record database, forwarding by the reimbursement system the confirmed edited charging record document to an accounting system of said business entity, and then the accounting system based on the confirmed edited charging record document transferring a respective amount of money into the bank account of said employee.

4. The travel expense reimbursement method according to claim 1, wherein said employee is authorized by said reimbursement system to delete a specific one of said charging data of said charging record document when said employee edits said charging record document.

5. The travel expense reimbursement method according to claim 1, wherein said employee is authorized by said reimbursement system to add at least a specific new charging data into said charging record document when said employee edits said charging record document.

6. The travel expense reimbursement method according to claim 1, wherein said employee is authorized by said reimbursement system to amend a specific one of said charging data of said charging record document when said employee edits said charging record document.

7. A travel expense reimbursement system, constructed in the computer facility in a business entity, each employee of the business entity having an individual employee's identification code to login the reimbursement system, the employee charging the expenses to a credit card issued by a specific credit card company during his/her traveling, the credit card including an individual credit card identification code with respect to the employee's identification code, receiving employee's charging data from the credit card company, said system comprising:
a credit card charging record database for storing the charging data, in which each of the charging data is respective to a credit card identification code; and
a database management program for the employee to retrieve all charging data of a travel with respect to the credit card identification code and the employee's identification code from the credit card charging record database for forming a charging record document respective to the travel when the employee uses the employee's identification code to login the reimbursement system, for allowing the employee to edit the charging record document, and for restoring the edited charging record document into the credit card charging record database.

8. The travel expense reimbursement system according to claim 7 further includes a plurality of control modules for, after said employee restores said edited charging record document into said credit card charging record database, said control modules notify the supervisor of said employee to login said reimbursement system to assess said edited charging record document, and restore said edited charging record document into said credit card charging record database after the supervisor confirms said edited charging record document.

9. The travel expense reimbursement system according to claim 8, wherein after said supervisor confirms said edited charging record document and restores the confirmed edited charging record document into said credit card charging record database, said control modules forward the confirmed edited charging record document to an accounting system of said business entity, and then the accounting system bases on the confirmed edited charging record document to transfer a respective amount of money into the bank account of said employee.

10. The travel expense reimbursement system according to claim 7, wherein said database management program allows said employee to delete a specific one of said charging data of said charging record document when said employee edits said charging record document.

11. The travel expense reimbursement system according to claim 7, wherein said database management program allows said employee to add at least a specific new charging data into said charging record document when said employee edits said charging record document.

12. The travel expense reimbursement system according to claim 7, wherein said database management program allows aid employee to amend a specific one of said charging data of said charging record document when said employee edits said charging record document.

13. The travel expense reimbursement system according to claim 7, wherein said computer facility is a network server.
